(19) United States
(12) Patent Application Publication
(10) Pub. No.: US 2021/0011788 A1
(43) Pub. Date: Jan. 14, 2021

(54) VECTOR PROCESSING FOR RPC INFORMATION

(71) Applicant: Alibaba Group Holding Limited, George Town, Grand Cayman (KY)

(72) Inventors: Shaosheng Cao, Hangzhou (CN); Jun Zhou, Hangzhou (CN)

(73) Assignee: Alibaba Group Holding Limited, George Town, Grand Cayman (KY)

(21) Appl. No.: 16/960,302

(22) PCT Filed: Jan. 16, 2019
(86) PCT No.: PCT/CN2019/071853

§ 371 Date: Jul. 6, 2020

(30) Foreign Application Priority Data
Mar. 15, 2018 (CN) 201810215719.5

(51) Int. Cl. G06F 9/54; G06N 20/00

(52) U.S. Cl. CPC G06F 9/547; G06N 20/00

(57) ABSTRACT

Embodiments of the present specification disclose a vector-processing method, apparatus, and device for RPC information. The scheme comprises: acquiring an RPC-information sequence consisting of a plurality of RPC-information units of a user; establishing and initializing feature vectors of the RPC-information units; and training the feature vectors according to the RPC-information sequence and the feature vectors, so as to obtain feature vectors with accurate expression.

### CROSS-REFERENCE TO RELATED APPLICATIONS

This patent application claims priority to Chinese patent Application No. 201810215719.5, filed on Mar. 15, 2018 and entitled “VECTOR PROCESSING METHOD, APPARATUS, AND DEVICE FOR RPC INFORMATION,” which is incorporated herein by reference in its entirety.

### FIELD

The disclosure is related to the field of computer software technologies, and in particular, to a vector-processing method, apparatus, and device for remote procedure calls (RPCs).

### BACKGROUND

RPC is a protocol to request service from a remote computer program through a network, without having to understand the underlying network technology. RPC-information sequences of users are often recorded in commercial applications to facilitate recommendation, automatic question answering, risk control, and so on. An RPC-information sequence consists of a plurality of RPC-information units. Each RPC unit is usually a specific string of encoded characters and has a specific meaning. For example, some RPC-information units may represent “querying a real-time value of a financial product,” “searching for new sweaters of a clothing brand,” and so on.

In existing technologies, manual labor is used to categorize different RPC units and summarize knowledge from the business perspective, in order to implement the relevant functions.

A more effective characterization scheme for RPC information is needed based on the current technologies.

### SUMMARY

Embodiments of the disclosure provide a vector-processing method, apparatus, and device for RPC information, in order to solve the following technical problem: a more effective characterization scheme for RPC information is desired.

To solve the above technical problem, the disclosed embodiments are implemented as follows.

A vector-processing method for RPC information provided in one embodiment comprises: acquiring an RPC-information sequence consisting of a plurality of RPC-information units of a user, establishing and initializing feature vectors of the RPC-information units, and training the feature vectors according to the RPC-information sequence and the feature vectors.

A vector-processing apparatus for RPC information provided in one embodiment comprises: an acquisition module, configured to acquire an RPC-information sequence consisting of a plurality of RPC-information units of a user; a construction module, configured to establish and initialize feature vectors of the RPC-information units; and a training module, configured to train the feature vectors according to the RPC-information sequence and the feature vectors.

Another vector-processing method for RPC information provided in one embodiment comprises:

operation 1: collecting an RPC-information sequence of a user, collecting statistics on and creating a table to store RPC-information units having occurred in the RPC-information sequence and having an occurrence count less than a predetermined value; proceeding to operation 2;

operation 2: establishing and initializing feature vectors of the RPC-information units in the above table; proceeding to operation 3;

operation 3: traversing the RPC-information sequence, separately performing operation 4 on a currently traversed RPC-information unit w; and ending the process if the traversing is completed; otherwise, continuing the traversing;

operation 4: establishing a window centered around w by sliding up to k RPC-information units to both sides; selecting multiple contextual RPC-information units of w from the window, and randomly selecting λ negative RPC-information unit samples of w from the RPC-information sequence; proceeding to operation 5;

operation 5: individually or collectively determining a feature vector for each of the contextual RPC-information units of w to serve as a contextual vector, and calculating a corresponding loss characterization value according to the following loss function l(w,c):

$$l ( w , c ) = log σ ( \vec{w} • \vec{c} ) + {\sum }_{i = 1}^{λ} {E}_{{c}^{′} ∈ p ( V )} [ log σ ( - \vec{w} • \vec{{c}^{′}} ) ] ,$$

where \vec{w} represents a feature vector of w; \vec{c} represents the contextual vector; c′ represents a negative RPC-information unit sample; ⊙ represents a similarity operation, wherein the similarity operation is a tensor product operation or a calculation of cosine of the angle between the two vectors; \vec{c}′ represents a feature vector of c′; E_{c′∈p(V)}[x] refers to an expected value of an expression x when c′ satisfies a probability distribution p(V), and σ( ) is a neural network excitation function and defined as

$$σ ( x ) = \frac{1}{1 + exp ( - x )} ;$$

and

calculating a corresponding gradient according to the calculated l(w,c), and updating \vec{w} and the feature vectors of its contextual RPC-information units according to the gradient.

One embodiment provides a vector-processing device for RPC information, comprising: at least one processor, and a memory communicating with the at least one processor. The memory stores instructions executable by the at least one processor, and the instructions are executed by the at least one processor, causing the at least one processor to: acquire an RPC-information sequence consisting of a plurality of RPC-information units of a user, establish and initialize feature vectors of the RPC-information units, and perform training on the feature-vectors according to the RPC-information sequence and the feature vectors.

The above at least one technical solution implemented by the disclosed embodiments may achieve the following beneficial effects: feature vectors of RPC-information units may be constructed and trained; and the trained feature vectors may be used to characterize internal semantic features of the RPC-information units more effectively.

### BRIEF DESCRIPTION OF THE FIGURES

To describe the technical solutions of the disclosed embodiments more clearly, the following descriptions briefly introduces the accompanying drawings for describing the embodiments. It is apparent that the accompanying drawings described below are only a part of the disclosed embodiments, and those of ordinary skill in the art may be able to derive other drawings from these accompanying drawings without creative efforts.

FIG. 1 is a schematic diagram illustrating an overall architecture of a disclosed solution involved in a practical application scenario;

FIG. 2 is a flowchart illustrating a vector-processing method for RPC information, according to one disclosed embodiment;

FIG. 3 is a flowchart illustrating an alternative vector-processing method for RPC information, according to one disclosed embodiment;

FIG. 4 is a flowchart illustrating a specific implementation of the aforementioned vector-processing method in a practical application scenario, according to one disclosed embodiment;

FIG. 5 is a flowchart illustrating an alternative implementation of the aforementioned vector-processing method in a practical application scenario, according to one disclosed embodiment; and

FIG. 6 is a schematic diagram of a vector-processing apparatus for RPC information corresponding to FIG. 2, according to one disclosed embodiment.

### DETAILED DESCRIPTION

Embodiments of the present disclosure provide a vector-processing method, apparatus, and device for RPC information.

In order to enable those skilled in the art to better understand the technical solutions in the present disclosure, the technical solutions in the disclosed embodiments will be described clearly and completely below with reference to the accompanying drawings. It is apparent that the described embodiments are merely some, rather than all, of the embodiments of the present application. All other embodiments obtained by a person of ordinary skill in the art based on the disclosed embodiments without creative efforts shall fall within the protection scope of the present application.

In view of the problem described in the Background, the present disclosure provides an unsupervised algorithm, which maps different RPC-information units to the same vector space of a fixed dimension to obtain feature vectors (also referred to as vector representations of RPC-information units or RPC vector representations). Based on this algorithm, an RPC-information sequence reflecting business behaviors of a user may further be vectorized to be directly used in tasks like intention recognition and merchandise recommendation. On the other hand, the RPC vector representations may further be subjected to dimension reduction to obtain a planar visualization graph, thereby facilitating business operation personnel in analyzing the data directly.

To facilitate easy understanding, an example of a risk-control scenario is used for description. For example, when an RPC-information sequence representing the following information “ . . . ‘login’, “incorrect authentication information for password reset,’ ‘incorrect authentication information for password reset,’ ‘incorrect authentication information for password reset,’ ‘incorrect authentication information for password reset’ . . . ” is present, the risk-control system should detect user operations being abnormal. A conventional method is to summarize this specific pattern of the RPC-information sequence manually. However, the number of RPC-information units increases continuously, and new patterns are constantly generated, which makes it difficult for manual summaries to cover every aspect. A classification model in machine learning may be used. That is, same RPC-information units are treated as one feature. However, the disadvantage of this solution is that characterizing the internal relationships among RPC-information units is difficult; this solution simply treats different RPC-information units differently on the surface level. The present disclosure proposes a solution to convert RPC-information units into vector representations, thus further characterizing internal semantic features among the RPC-information units.

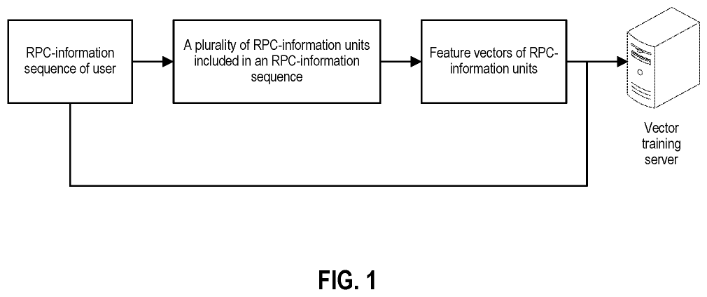

FIG. 1 is a schematic diagram illustrating an overall architecture of a disclosed solution involved in a practical application scenario. The overall architecture mainly involves four parts: an RPC-information sequence of a user; a plurality of RPC-information units included in the RPC-information sequence, feature vectors of the RPC-information units, and a vector-training server. One can obtain more accurate feature vectors by training the feature vectors of the RPC-information units using the vector-training server. In practical applications, operations involved in the first three parts may be performed by corresponding software and/or hardware functional modules.

The following describes the disclosed solutions in detail with reference to the exemplary architecture shown in FIG. 1.

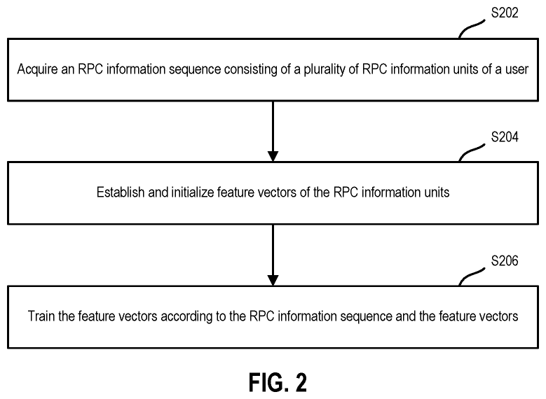

FIG. 2 is a flowchart illustrating a vector-processing method for RPC information, according to one disclosed embodiment. From a programming perspective, the execution body of the workflow may be a program having a vector-training function and the like; from a device perspective, the execution body of the workflow may include, but is not limited to, at least one of the following devices capable of carrying the program: a personal computer, a large and medium-sized computer, a computer cluster, a mobile phone, a tablet computer, a smart wearable device, an in-vehicle computer, and so on.

The workflow in FIG. 2 may include the following operations:

S202: acquire an RPC-information sequence consisting of a plurality of RPC-information units of a user.

In the disclosed embodiments, the RPC-information units in the RPC-information sequence are generally arranged in a temporal order to reflect several sequential business behaviors of the user within a time period. In the aforementioned example of the risk-control scenario, the RPC-information sequence may reflect the user's behaviors of login, followed by several successive attempts to reset the password (but the password-reset attempts fail due to the inaccurate authentication information for password reset). Information such as “login” and “inaccurate authentication information for password reset” may be separately represented by one RPC-information unit in the RPC-information sequence. The representation format of the RPC-information unit is not limited, which may be a character string or an encoded character string.

S204: establish and initialize feature vectors of the RPC-information units.

In the disclosed embodiments, the RPC-information units in operation S204 refer to at least a portion of RPC-information units having occurred in the RPC-information sequence. To facilitate subsequent processing, these RPC-information units can be recorded in a table; and the RPC-information units can be read from the table when needed.

In one disclosed embodiment, each RPC-information unit has its own feature vector, and feature vectors of the same RPC-information units are the same.

In one disclosed embodiment, certain restrictions cam be applied when the feature vectors are initialized. For example, do not initialize all feature vectors into a same vector; moreover, values of elements in some feature vectors are not all 0, and so on. The feature vector of each RPC-information unit can be initialized randomly or according to a specified probability distribution (for example, a 0-1 distribution, etc.).

In addition, if the feature vectors of some RPC-information units have been previously trained based on other training data, then, when training is further performed based on the RPC-information sequence in FIG. 2, it is no longer needed to establish and initialize the feature vectors of these RPC-information units; instead, further training can be performed based on the previous training result.

S208: train the feature vectors according to the RPC-information sequence and the feature vectors.

In the disclosed embodiments, the feature vectors may be trained using unsupervised learning according to contextual relationship in the RPC-information sequence.

Using the method in FIG. 2, the feature vectors of RPC-information units may be constructed and trained; and the trained feature vectors may characterize internal semantic features among the RPC-information units more effectively.

Based on the method in FIG. 2, the disclosed embodiments further provide some specific implementations and extension solutions, which will be described below.

In one disclosed embodiment, considering that, if an RPC-information unit having a very low occurrence frequency in an RPC-information sequence, there will be fewer corresponding training samples and training frequencies while performing training based on the RPC-information sequence, thus brining an adverse effect to the reliability of the training result. Consequently, such RPC-information unit can be removed from training for the time being. The training may be performed later using other suitable training data. In practical applications, the RPC-information sequence itself may also filter out such RPC-information units.

Based on the analysis in the above paragraph, establishing and initializing feature vectors of the RPC-information units described in operation S204 may specifically include: determining RPC-information units having an occurrence frequency in the RPC-information sequence not less than a predetermined number; and establishing and initializing feature vectors of each of the determined RPC-information units, where feature vectors of the same RPC-information units are also the same. The predetermined number is no less than 1, and the specific number may be determined according to actual needs.

In one disclosed embodiment, with regard to operation S206, there can be many specific training manners, for example, a training manner based on context and a training manner based on near-synonymous or synonymous RPC-information units. For ease of understanding, the former manner is used as an example for detailed description.

Training the feature vectors according to the RPC-information sequence and the feature vectors can specifically include: determining a specified RPC-information unit in the RPC-information sequence and one or more contextual RPC-information units of the specified RPC-information unit in the RPC-information sequence; individually or collectively determining a feature vector for each of the contextual RPC-information units of the specified RPC-information unit to serve as a contextual vector; determining a similarity between the specified RPC-information unit and a contextual RPC-information unit thereof according to the feature vector of the specified RPC-information unit and the contextual vector; and updating the feature vector of the specified RPC-information unit according to the similarity between the specified RPC-information unit and the contextual RPC-information unit thereof.

If there are multiple contextual RPC-information units, in the case where feature vectors are to be determined individually, there will be multiple contextual vectors, which are feature vectors of each of the contextual RPC-information units; in the case where a feature vector is to be determined collectively, there will be only one contextual vector, which can be determined, for example, by performing operations such as averaging or obtaining maximum and minimum values according to respective feature vectors of each of the contextual RPC-information units.

The present disclosure does not limit the methods used to measure the similarity. For example, the similarity can be measured based on a calculation of a cosine of the angle between the vectors, or the similarity can be measured based on a calculation of the sum of squares of the vectors, and the like.

There might be multiple specified RPC-information units, and the specified RPC-information units may be repeated and located at different positions in the RPC-information sequence. The aforementioned operation can be performed for each specified RPC-information unit. Preferably, RPC-information units (some of which may have been filtered out) included in the RPC-information sequence can be separately used as a specified RPC-information unit.

In the disclosed embodiments, the training in operation S206 can cause: the similarity between the specified RPC-information unit and the contextual RPC-information unit thereof to be relatively higher (herein, the similarity can reflect a correlation; the correlation between an RPC-information unit and its contextual RPC-information units is relatively higher, and respective contextual RPC-information units of RPC-information units having the same or similar semantic meaning usually have the same or similar semantic meaning); and the similarity between the specified RPC-information unit and a non-contextual RPC-information unit thereof to be relatively lower. The non-contextual RPC-information unit may serve as a negative-sample RPC-information unit described below; and the contextual RPC-information unit, on the other hand, may serve as a positive-sample RPC-information unit.

Thus, during training, some negative sample RPC-information units may be determined for comparison, which helps to improve the training effect. One can randomly select one or more RPC-information units from the RPC-information sequence as negative-sample RPC-information units, or can rigorously select non-contextual RPC-information units as negative-sample RPC-information unit. Using the former case as an example, the aforementioned updating the feature vector of the specified RPC-information unit according to the similarity between the specified RPC-information unit and the contextual RPC-information unit thereof may specifically include: selecting one or a plurality of RPC-information units from the RPC-information sequence as negative-sample RPC-information unit of the specified RPC-information unit; determining a similarity between the specified RPC-information unit and the negative-sample RPC-information unit thereof; determining, based on a predetermined loss function, the similarity between the specified RPC-information unit and the contextual RPC-information unit thereof, and the similarity between the specified RPC-information unit and the negative sample RPC-information unit thereof, the loss representative value corresponding to the specified RPC-information unit; and updating the feature vector of the specified RPC-information unit according to the loss-representative value. Additionally, a feature vector of the contextual RPC-information unit and/or negative sample RPC-information unit of the specified RPC-information unit may further be updated according to the loss-representative value.

The loss-representative value is used to measure the error between a current vector value and a training target. The aforementioned several types of similarity may be used as parameters of the loss function. The specific expression of the loss function is not limited in the present disclosure and will be described in detail later.

In one disclosed embodiment, updating the feature vector in fact is correcting the error. When the disclosed solution is implemented using a neural network, such corrections can be implemented using backpropagation and gradient descent. In this case, the gradient is a gradient corresponding to the loss function.

Then, updating the feature vector of the specified RPC-information unit according to the loss-representative value may specifically include: determining a gradient corresponding to the loss function according to the loss-representative value, and updating the feature vector of the specified RPC-information unit according to the gradient.

In the disclosed embodiments, the training of the feature vectors can be performed iteratively based on at least some RPC-information units in the RPC-information sequence until the training converges.

The two solutions of determining a contextual vector in training have been described above, namely, determining individually or collectively a feature vector for each of the contextual RPC-information units of the specified RPC-information unit as a contextual vector. The training process can be further described based on these two respective solutions.

Using performing training based on all RPC-information units in the RPC-information sequence as an example, if the first solution of determining a contextual vector is used, then in operation S206, training the feature vectors according to the RPC-information sequence and the feature vectors can specifically include:

traversing the RPC-information sequence, and respectively performing, on the traversed RPC-information units (namely, those serving as the specified RPC-information units), the following:

determining one or more contextual RPC-information units of the RPC-information unit in the RPC-information sequence;

respectively performing the following on the aforementioned contextual RPC-information units:

determining a similarity between the RPC-information unit and the contextual RPC-information unit according to a feature vector of the RPC-information unit and a feature vector of the contextual RPC-information unit; and

updating the feature vector of the RPC-information unit and the feature vector of the contextual RPC-information unit according to the similarity between the RPC-information unit and the contextual RPC-information unit.

Using performing training based on all RPC-information units in the RPC-information sequence as an example, if the second solution of determining a contextual vector is used, then in operation S206, training the feature vectors according to the RPC-information sequence and the feature vectors can specifically include:

traversing the RPC-information sequence, and respectively performing, on the RPC-information units in the RPC-information sequence, the following:

determining one or more contextual RPC-information units of the RPC-information unit in the RPC-information sequence; determining a contextual vector according to respective feature vectors of the one or more contextual RPC-information units by performing operations such as averaging or obtaining maximum and minimum values; determining a similarity between the RPC-information unit and the contextual RPC-information unit thereof according to a feature vector of the RPC-information unit and the contextual vector; and updating the feature vectors of the RPC-information unit and the contextual RPC-information unit thereof according to the similarity between the RPC-information unit and the contextual RPC-information unit thereof.

The specific operations of how to perform the update have been described above. Details will not be repeated herein.

In the disclosed embodiment, to facilitate processing by computers, the aforementioned traversing process may be implemented based on a window.

For example, determining one or more contextual RPC-information units of the RPC-information unit in the RPC-information sequence can specifically include: within the RPC-information sequence, establishing a window using the RPC-information unit as a center and sliding to left and/or right a distance of a predetermined number of RPC-information units; and determining one or more RPC-information units in the window as contextual RPC-information units.

Certainly, one can use a first RPC-information unit of the RPC-information sequence as a start position to establish a window having a predetermined length, the window containing the first RPC-information unit and a predetermined number of successive RPC-information units thereafter; and after the RPC-information units in the window are processed, the window is slide backward to process the next batch of RPC-information units in the RPC-information sequence, until the RPC-information sequence is fully traversed.

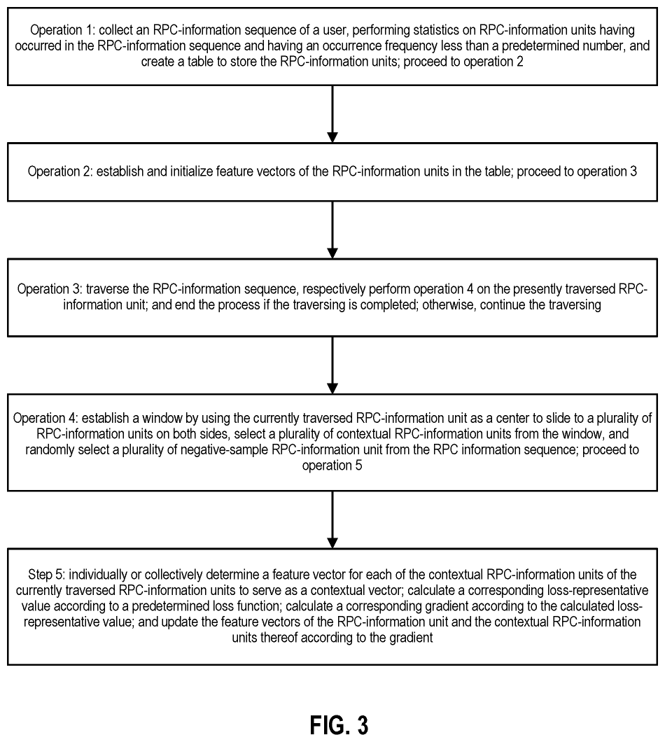

Based on the same idea of FIG. 2, one disclosed embodiment provides another vector-processing method for RPC information. FIG. 3 is a flowchart illustrating an alternative vector-processing method for RPC information, according to one disclosed embodiment.

The workflow in FIG. 3 can include the following operations:

operation 1: collect an RPC-information sequence of a user, collecting statistics on RPC-information units having occurred in the RPC-information sequence and having an occurrence frequency less than a predetermined number, and create a table to store the RPC-information units; proceed to operation 2;

operation 2: establish and initialize feature vectors of the RPC-information units in the table; proceed to operation 3;

operation 3: traverse the RPC-information sequence, respectively perform operation 4 on a currently traversed RPC-information unit w; and end the process if the traversing is completed; otherwise, continue the traversing;

operation 4: establish a window using w as a center and slide, to both sides, up to k RPC-information units; select a plurality of contextual RPC-information units of w from the window, and randomly select λ negative-sample RPC-information unit of w from the RPC-information sequence; proceed to operation 5;

operation 5: individually or collectively determine a feature vector for each of the contextual RPC-information units of w to serve as a contextual vector, and calculate a corresponding loss-representative value l(w,c) according to the following loss function:

$$l ( w , c ) = log σ ( \vec{w} • \vec{c} ) + {\sum }_{i = 1}^{λ} {E}_{{c}^{′} ∈ p ( V )} [ log σ ( - \vec{w} • \vec{{c}^{′}} ) ] ;$$

where \vec{w} represents a feature vector of w, \vec{c} represents the contextual vector, c′ represents a negative-sample RPC-information unit of w, □ represents a similarity operation, where the similarity operation is a tensor-product operation or calculating the cosine of the angle between the vectors, \vec{c}′ represents a feature vector of c′, E_{c′∈p(V)}[x] refers to an expected value of an expression x when c′ satisfies a probability distribution p(V), and σ( ) is a neural network excitation function, defined as

$$σ ( x ) = \frac{1}{1 + exp ( - x )} ;$$

and

calculate a corresponding gradient according to the calculated l(w,c), and update the feature vectors of \vec{w} and the contextual RPC-information units thereof according to the gradient.

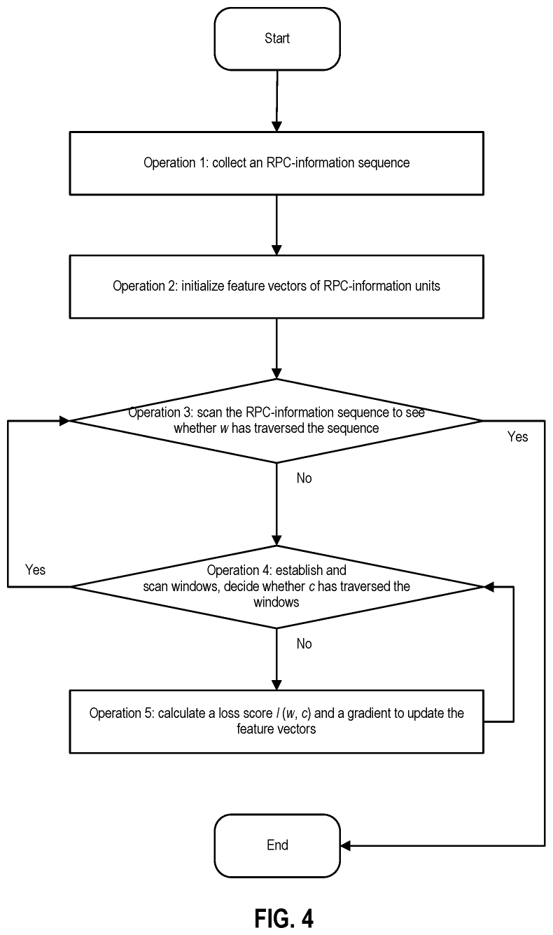

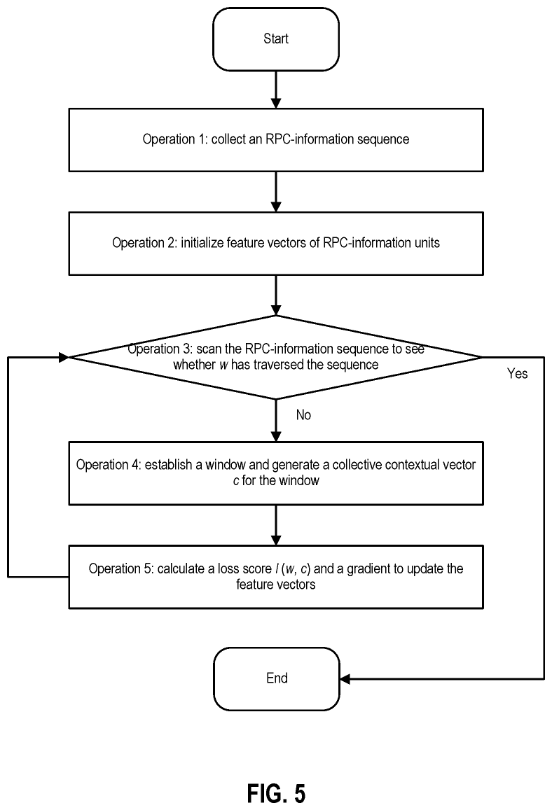

For ease of understanding, one disclosed embodiment further provides a flowchart illustrating the two specific implementation solutions (respectively corresponding to the two aforementioned solutions for determining the contextual vector) of the method in FIG. 3 in a practical application scenario. As shown in FIG. 4 and FIG. 5 respectively. In general, the solution in FIG. 4 has a higher accuracy, whereas the solution in FIG. 5 has a higher processing speed; and the difference therebetween mainly lies in operation 4. One may decide which solution to adopt based on practical needs.

The workflow in FIG. 4 mainly includes the following operations:

operation 1: collect an RPC-information sequence of a user; collect statistics on all RPC-information units having occurred and create a table to store the RPC-information units; and select and remove, from the table, RPC-information units having an occurrence frequency in the RPC-information sequence less than b (namely, the aforementioned predetermine number); proceed to operation 2;

operation 2: establish a feature vector having a dimension of d for each RPC-information unit in the table, and randomly initialize all the established feature vectors; proceed to operation 3;

operation 3: slide, from the first RPC-information unit, one unit at a time; select an RPC-information unit as a “currently traversed RPC-information unit w” each time; and if w traverses all RPC-information units in the RPC-information sequence, end the process; otherwise, proceed to operation 4;

operation 4: establish a window using w as the center to slide k RPC-information units to both sides; select an RPC-information unit as a “contextual RPC-information unit c” each time from the first RPC-information unit to the last RPC-information unit in the window (w may be excluded); and if c traverses all RPC-information units in the window, proceed to operation 3; otherwise, proceed to operation 5;

operation 5: for w, randomly extract λ words as negative-sample RPC-information units and calculate a loss score l(w, c) according to the following equation, where the loss score may serve as the aforementioned loss-representative value:

$$l ( w , c ) = log σ ( \vec{w} • \vec{c} ) + {\sum }_{i = 1}^{λ} {E}_{{c}^{′} ∈ p ( V )} [ log σ ( - \vec{w} • \vec{{c}^{′}} ) ] ;$$

calculate a gradient according to the loss score and update \vec{w} and \vec{c} according to the gradient.

The workflow in FIG. 5 mainly includes the following operations:

operation 1: collect an RPC-information sequence of a user; collect statistics on all RPC-information units having occurred and create a table to store the RPC-information units; and select and remove, from the table, RPC-information units having an occurrence frequency in the RPC-information sequence less than b (namely, the aforementioned predetermined number); proceed to operation 2;

operation 2: establish a feature vector having a dimension of d for each RPC-information unit in the table, and randomly initialize all the established feature vectors; proceed to operation 3;

operation 3: slide from the first RPC-information unit one at a time; select an RPC-information unit as a “currently traversed RPC-information unit w” each time; and if w traverses all RPC-information units in the RPC-information sequence, end the process; otherwise, proceed to operation 4;

operation 4: establish a window using w as the center to slide k RPC-information units to both sides; determine a plurality of contextual RPC-information units in the window; and collectively calculate a contextual vector according to feature vectors of these contextual RPC-information units, according to either one of the following two equations:

$$c ( j ) = \frac{1}{2 k} {\sum }_{i = 1}^{2 k} {y}_{i} ( j ) ;$$

$$c ( j ) = {max}_{i = 1 , 2 , . . . , 2 k} \{ {y}_{j} ( j ) \} ;$$

where, yᵢ(j) represents the jₜₕ dimension value of a feature vector of the iₜₕ contextual RPC-information unit, and c(j) represents the jₜₕ dimension value of c; proceed to operation 5;

operation 5: for w, randomly extract λ words as negative sample RPC-information unit and calculate a loss score l(w,c) according to equation (1), where the loss score may serve as the aforementioned loss-representative value:

$$l ( w , c ) = log σ ( sim ( w , c ) ) + {\sum }_{i = 1}^{λ} {E}_{{c}^{′} ∈ p ( V )} [ log σ ( - sin ( w , {c}^{′} ) ) ] ;$$

calculate a gradient according to the loss score; update \vec{w}, and update \vec{c} and/or feature vectors of the contextual RPC-information units according to the gradient.

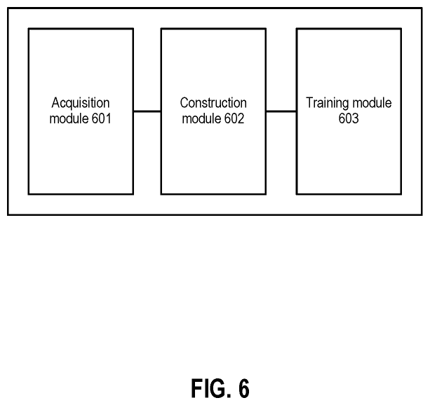

The vector-processing methods for RPC information provided in embodiments of the present disclosure have been described above. Based on the same idea, one disclosed embodiment further provides a corresponding apparatus, as shown in FIG. 6.

FIG. 6 is a schematic diagram of a vector-processing apparatus for RPC information corresponding to FIG. 2, according to one disclosed embodiment. The apparatus may be located in the execution body of the workflow in FIG. 2 and include: an acquisition module 601, configured to acquire an RPC-information sequence consisting of a plurality of RPC-information units of a user; a construction module 602, configured to establish and initialize feature vectors of the RPC-information units; and a training module 603, configured to train the feature vectors according to the RPC-information sequence and the feature vectors.

Optionally, construction module 602 establishing and initializing feature vectors of the RPC-information units specifically includes: construction module 602 determining RPC-information units having an occurrence frequency in the RPC-information sequence no less than a predetermined number; and establishing and initializing feature vectors of each of the determined RPC-information units, where feature vectors for the same RPC-information units are also the same.

Optionally, training module 603 training the feature vectors according to the RPC-information sequence and the feature vectors specifically includes: training module 603 determining a specified RPC-information unit in the RPC-information sequence and one or a plurality of contextual RPC-information units of the specified RPC-information unit in the RPC-information sequence; individually or collectively determining a feature vector for each of the contextual RPC-information units of the specified RPC-information unit to serve as a contextual vector; determining a similarity between the specified RPC-information unit and the contextual RPC-information unit thereof according to a feature vector of the specified RPC-information unit and the contextual vector; and updating the feature vector of the specified RPC-information unit according to the similarity between the specified RPC-information unit and the contextual RPC-information unit thereof.

Optionally, training module 603 updating the feature vector of the specified RPC-information unit according to the similarity between the specified RPC-information unit and the contextual RPC-information unit thereof specifically includes: training module 603 selecting one or a plurality of RPC-information units from the RPC-information sequence to serve as negative-sample RPC-information units of the specified RPC-information unit; determines a similarity between the specified RPC-information unit and the negative-sample RPC-information units thereof; determining a loss-representative value corresponding to the specified RPC-information unit according to a predetermined loss function, the similarity between the specified RPC-information unit and the contextual RPC-information unit thereof, and the similarity between the specified RPC-information unit and the RPC-information unit negative sample thereof; and updating the feature vector of the specified RPC-information unit according to the loss representative value.

Optionally, training module 603 selecting one or a plurality of RPC-information units from the RPC-information sequence to serve as negative-sample RPC-information unit of the specified RPC-information unit specifically includes: training module 603 randomly selecting one or a plurality of RPC-information units from the RPC-information sequence to serve as the negative-sample RPC-information units of the specified RPC-information unit.

Optionally, training module 603 training the feature vectors according to the RPC-information sequence and the feature vectors specifically includes: training module 603 traversing the RPC-information sequence; and respectively performing the following on the traversed RPC-information units: determining one or a plurality of contextual RPC-information units of the RPC-information unit in the RPC-information sequence; respectively performing the following on the contextual RPC-information units: determining a similarity between the RPC-information unit and the contextual RPC-information unit according to a feature vector of the RPC-information unit and a feature vector of the contextual RPC-information unit; and updating the feature vector of the RPC-information unit and the feature vector of the contextual RPC-information unit according to the similarity between the RPC-information unit and the contextual RPC-information unit.

Optionally, training module 603 training the feature vectors according to the RPC-information sequence and the feature vectors specifically includes: training module 603 traversing the RPC-information sequence, and respectively performing the following on RPC-information units in the RPC-information sequence: determining one or a plurality of contextual RPC-information units of the RPC-information unit in the RPC-information sequence; determining a contextual vector according to respective feature vectors of the one or plurality of contextual RPC-information units by performing operations such as averaging or obtaining maximum and minimum values; determining a similarity between the RPC-information unit and the contextual RPC-information unit thereof according to a feature vector of the RPC-information unit and the contextual vector; and updating the feature vectors of the RPC-information unit and the contextual RPC-information unit thereof according to the similarity between the RPC-information unit and the contextual RPC-information unit thereof.

Optionally, training module 603 determining one or a plurality of contextual RPC-information units of the RPC-information unit in the RPC-information sequence specifically includes: training module 603 establishing a window using the RPC-information unit as the center to slide to the left and/or right side a distance of a predetermined number of RPC-information units in the RPC-information sequence; and determining one or a plurality of RPC-information units in the window to serve as contextual RPC-information units.

Based on the same idea, one disclosed embodiment further provides a vector-processing device for RPC information that corresponds to FIG. 2, including: at least one processor, and a memory in communication with the at least one processor. T he memory stores instructions executable by the at least one processor, and the instructions are executed by the at least one processor to enable the at least one processor to: acquire an RPC-information sequence consisting of a plurality of RPC-information units of a user, establish and initialize feature vectors of the RPC-information units, and train the feature vectors according to the RPC-information sequence and the feature vectors.

Based on the same idea, one disclosed embodiment further provides a non-volatile computer storage medium that corresponds to FIG. 2; the non-volatile computer storage medium stores thereon computer-executable instructions configured to: acquire an RPC-information sequence consisting of a plurality of RPC-information units of a user, establish and initialize feature vectors of the RPC-information units, and train the feature vectors according to the RPC-information sequence and the feature vectors.

The specific embodiments of the present disclosure have been described above. Other embodiments fall within the scope of the appended claims. In some cases, operations or steps recited in the claims may be executed in an order different from what in the embodiments to still achieve desired results. In addition, the processes depicted in the accompanying drawings do not necessarily require the illustrated particular order or sequential order to achieve the desired results. In some implementations, multi-tasking and parallel processing are also possible or may be beneficial.

The embodiments in the present disclosure are described in a progressive manner; and reference for parts of different embodiments that are identical or similar may be made to each other so that each of the embodiments focuses on differences from other embodiments. In particular, since the apparatus, electronic device, and non-volatile computer storage medium embodiments are basically similar to the method embodiments, the description thereof is relatively brief. For related parts, reference may be made to part of the description of the method embodiments.

The apparatus, electronic device, and non-volatile computer storage medium provided in the embodiments of the present disclosure correspond to the methods. Therefore, the apparatus, electronic device, and non-volatile computer storage medium also have beneficial technical effects similar to those of the corresponding methods. As the beneficial technical effects of the methods have been illustrated in detail previously, the beneficial technical effects of the corresponding apparatus, electronic device, and non-volatile computer storage medium will not be described herein again.

In the 1990s, whether a technical improvement is a hardware improvement (for example, an improvement to a circuit structure such as a diode, a transistor, or a switch) or a software improvement (an improvement to a procedure) can be differentiated clearly. However, following the development of technologies, many current improvements to procedures may be regarded as direct improvements to hardware circuit structures. A designer usually programs an improved procedure into a hardware circuit to obtain a corresponding hardware circuit structure. Therefore, a procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application-specific integrated circuit chip. In addition, at present, instead of manually manufacturing an integrated circuit chip, this type of programming is mostly implemented by using “logic compiler” software. The logic compiler software is similar to a software compiler used to develop and write a program. Original code needs to be written in a particular programming language for compilation. The language is referred to as a hardware description language (HDL). There are many HDLs, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, and Ruby Hardware Description Language (RHDL). The very-high-speed integrated circuit hardware description language (VHDL) and Verilog are most commonly used. A person skilled in the art should also understand that a hardware circuit that implements a logical method procedure may be readily obtained once the method procedure is logically programmed using the several described hardware description languages and is programmed into an integrated circuit.

A controller may be implemented using any suitable manner. For example, the controller may be in the form of a microprocessor or processor and a computer-readable medium that stores computer-readable program code (for example, software or firmware) executable by the (micro)processor, logic gates, switches, an application specific integrated circuit (ASIC), a programmable logic controller, and a built-in microcontroller. The examples of the controller include, but are not limited to, the following microcontrollers: ARC 625D, Atmel AT91SAM, Microchip PIC18F26K20, and Silicone Labs C8051F320. The memory controller may also be implemented as a part of the control logic of the memory. A person skilled in the art also knows that, in addition to implementing the controller by using the computer readable program code, logic programming may be performed on method steps to allow the controller to implement the same function in forms of a logic gate, a switch, an application-specific integrated circuit, a programmable logic controller, and a built-in microcontroller. Therefore, such a controller may be regarded as a hardware component, and an apparatus included therein for implementing various functions may be regarded as an internal structure of the hardware component. Or the apparatus configured to implement various functions may even be considered as both a software module implementing the method and a structure in the hardware component.

The system, apparatus, module, or unit illustrated in the aforementioned embodiments may be specifically implemented by using a computer chip or an entity, or may be implemented using a product having a certain function. A typical implementation device is a computer. Specifically, the computer may be, for example, a personal computer, a laptop computer, a cell phone, a camera phone, a smartphone, a personal digital assistant, a media player, a navigation device, an email device, a game console, a tablet computer, a wearable device, or a combination of any of these devices.

For ease of description, the above apparatus is described by dividing functions into various units. Certainly, when implementing the present specification, the functions of various units may be implemented in one or a plurality of instances of software and/or hardware.

Those skilled in the art should understand that the embodiments of the present specification may be provided as a method, a system, or a computer program product. Therefore, the embodiments of the present specification may take the form of hardware only implementations, software only implementations, or implementations with a combination of software and hardware. Moreover, the embodiments of the present specification may take the form of a computer program product which is embodied on one or more computer-usable storage media (including, but not limited to, a magnetic disk storage, a CD-ROM, an optical storage, and so forth) having computer-usable program code included therein.

The present specification is described with reference to the flowcharts and/or block diagrams of the method, the device (system), and the computer program product according to the embodiments of the present specification. It should be understood that computer program instructions may be used to implement each process and/or each block in the flowcharts and/or the block diagrams and a combination of a process and/or a block in the flowcharts and/or the block diagrams. These computer program instructions may be provided to a general-purpose computer, a dedicated computer, an embedded processor, or a processor of another programmable data processing device to generate a machine, so that the instructions executed by a computer or a processor of another programmable data processing device generate an apparatus for implementing a specific function in one or more processes in the flowcharts and/or in one or more blocks in the block diagrams.

These computer program instructions may also be stored in a computer-readable memory that can instruct the computer or another programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device, so that a series of operations and steps are performed on the computer or another programmable device to generate computer-implemented processing. Therefore, the instructions executed on the computer or another programmable device are used to provide steps for implementing a specific function in one or more processes in the flowcharts and/or in one or more blocks in the block diagrams.

In one typical configuration, a computer device comprises one or a plurality of processing units (CPUs), input/output interfaces, network interfaces, and memory.

A memory may include a volatile storage device on a computer-readable medium, a random access memory (RAM), and/or a non-volatile memory, such as a read-only memory (ROM), or a flash memory (flash RAM). A memory may be an example of the computer-readable medium.

Computer-readable media include both permanent and non-permanent, removable and non-removable media, and may store information by any method or technology. The information may be computer-readable instructions, data structures, modules of programs or other data. Examples of computer storage media include, but are not limited to, a phase change memory (PRAM), a static random access memory (SRAM), a dynamic random access memory (DRAM), other types of random access memories (RAMs), a read only memory (ROM), an electrically erasable programmable read-only memory (EEPROM), a flash memory or other memory technologies, a compact disk read-only memory (CD-ROM), a digital versatile disc (DVD) or other optical storage devices, a cassette type magnetic tape, a magnetic tape/magnetic disk storage or other magnetic storage devices or any other non-transmission medium, and may be used for storing information accessible by computing devices. As defined herein, the computer-readable media do not include transitory media, such as modulated data signals and carriers.

It should also be noted that the term “comprise,” “include,” or any other variant thereof is intended to encompass a non-exclusive inclusion, so that a process, method, product, or device that involves a series of elements comprises not only those elements, but also other elements not explicitly listed, or elements that are inherent to such a process, method, product, or device. Without more restrictions, an element defined by the phrase “including a . . . ” does not exclude the presence of another same element in a process, method, product, or device that comprises the element.

Those skilled in the art should understand that the embodiments of the present specification may be provided as a method, a system, or a computer program product. Therefore, the present specification may take the form of hardware only implementations, software only implementations, or implementations with a combination of software and hardware. Moreover, the present specification may take the form of a computer program product which is embodied on one or more computer-usable storage media (including, but not limited to, a magnetic disk storage, a CD-ROM, an optical storage, and so forth) having computer-usable program code included therein.

The present specification may be described in a general context of computer-executable instructions executed by a computer, such as a program module. Generally, the program module includes a routine, a program, an object, a component, a data structure, and the like for executing a specific task or implementing a specific abstract data type. The present specification may also be implemented in distributed computing environments. In distributed computing environments, tasks are executed by remote processing devices that are connected through a communication network. In the distributed computing environment, the program module may be located in both local and remote computer storage media including storage devices.

The embodiments in the present specification are described in a progressive manner; and reference for parts of different embodiments that are identical or similar may be made to each other so that each of the embodiments focuses on differences from other embodiments. In particular, since the system embodiment is basically similar to the method embodiment, the description is relatively simple. For related parts, reference may be made to part of the description of the method embodiments.

The above descriptions are merely the embodiments of the present disclosure, and are not intended to limit the present application. For those skilled in the art, the present application may have various modifications and changes. Any modifications, equivalent substitutions, improvements and the like made within the spirit and principle of the present application shall fall within the scope of the claims of the present application.

1. A vector-processing method for remote procedure call (RPC) information, the method comprising:
acquiring an RPC-information sequence consisting of a plurality of RPC-information units of a user;
establishing and initializing feature vectors of the RPC-information units; and
training the feature vectors according to the RPC-information sequence and the feature vectors.

2. The method according to claim 1, wherein establishing and initializing feature vectors of the RPC-information units comprises:
determining RPC-information units having an occurrence frequency in the RPC-information sequence no less than a predetermined number; and
establishing and initializing feature vectors of each of the determined RPC-information units, wherein feature vectors for same RPC-information units are also the same.

3. The method according to claim 1, wherein training the feature vectors according to the RPC-information sequence and the feature vectors comprises:
determining a specified RPC-information unit in the RPC-information sequence and one or a plurality of contextual RPC-information units of the specified RPC-information unit in the RPC-information sequence;
individually or collectively determining a feature vector for each of the contextual RPC-information units of the specified RPC-information unit as a contextual vector;
determining a similarity between the specified RPC-information unit and the contextual RPC-information unit thereof according to a feature vector of the specified RPC-information unit and the contextual vector; and
updating the feature vector of the specified RPC-information unit according to the similarity between the specified RPC-information unit and the contextual RPC information unit thereof.

4. The method according to claim 3, wherein updating the feature vector of the specified RPC-information unit according to the similarity between the specified RPC-information unit and the contextual RPC-information unit thereof comprises:
selecting one or a plurality of RPC-information units from the RPC-information sequence as negative-sample RPC-information units of the specified RPC-information unit;
determining a similarity between the specified RPC-information unit and the negative-sample RPC-information unit thereof;
determining a loss-representative value corresponding to the specified RPC-information unit according to a specified loss function, the similarity between the specified RPC-information unit and the contextual RPC-information unit thereof, and the similarity between the specified RPC-information unit and the negative sample RPC-information unit thereof; and
updating the feature vector of the specified RPC information unit according to the loss-representative value.

5. The method according to claim 4, wherein selecting one or a plurality of RPC-information units from the RPC-information units as negative-sample RPC-information units of the specified RPC-information unit comprises:
randomly selecting one or a plurality of RPC-information units from each of the RPC information units as the negative-sample RPC information units of the specified RPC-information unit.

6. The method according to claim 1, wherein training the feature vectors according to the RPC-information sequence and the feature vectors comprises:
traversing the RPC-information sequence, and respectively performing, on the traversed RPC-information units, following:
determining one or a plurality of contextual RPC-information units of the RPC-information unit in the RPC-information sequence;
respectively performing, on the contextual RPC-information unit, following:
determining a similarity between the RPC-information unit and the contextual RPC-information unit according to a feature vector of the RPC-information unit and a feature vector of the contextual RPC-information unit; and
updating the feature vector of the RPC-information unit and the feature vector of the contextual RPC-information unit according to the similarity between the RPC-information unit and the contextual RPC-information unit.

7. The method according to claim 1, wherein training the feature vectors according to the RPC-information sequence and the feature vectors comprises:
traversing the RPC-information sequence, and respectively performing, on RPC information units in the RPC information sequence, following:
determining one or a plurality of contextual RPC-information units of the RPC-information unit in the RPC-information sequence;
determining a contextual vector according to respective feature vectors of the one or plurality of contextual RPC-information units by calculating an average value or maximum and minimum values;
determining a similarity between the RPC information unit and the context RPC information unit thereof according to a feature vector of the RPC information unit and the context vector; and
updating the feature vectors of the RPC-information unit and the contextual RPC-information unit thereof according to the similarity between the RPC-information unit and the contextual RPC-information unit thereof.

8. The method according to claim 1, wherein training the feature vectors comprises determining one or a plurality of contextual RPC-information units of a particular RPC-information unit in the RPC-information sequence, and wherein determining one or a plurality of contextual RPC-information units of the particular RPC-information unit in the RPC-information sequence comprises:
establishing a window using the particular RPC-information unit as a center and sliding to left and/or right side a distance of a predetermined number of RPC-information units in the RPC-information sequence; and
determining one or a plurality of RPC-information units in the window as the contextual RPC-information units.

9. A vector-processing apparatus for remote procedure call (RPC) information, the apparatus comprising:
an acquisition module configured to acquire an RPC-information sequence consisting of a plurality of RPC-information units of a user;
a construction module configured to establish and initialize feature vectors of the RPC-information units; and
a training module configured to train the feature vectors according to the RPC-information sequence and the feature vectors.

10. The apparatus according to claim 9, wherein the construction module establishing and initializing feature vectors of the RPC information units comprises:
the construction module determining RPC-information units having an occurrence frequency in the RPC-information sequence no less than a predetermined number; and
establishing and initializing feature vectors of each of the determined RPC-information units, wherein feature vectors for same RPC-information units are also the same.

11. The apparatus according to claim 9, wherein the training module training the feature vectors according to the RPC-information sequence and the feature vectors comprises:
the training module determining a specified RPC-information unit in the RPC-information sequence and one or a plurality of contextual RPC-information units of the specified RPC-information unit in the RPC-information sequence;
individually or collectively determining a feature vector for each of the contextual RPC-information units of the specified RPC-information unit as a contextual vector;
determining a similarity between the specified RPC-information unit and the contextual RPC-information unit thereof according to a feature vector of the specified RPC-information unit and the contextual vector; and
updates the feature vector of the specified RPC-information unit according to the similarity between the specified RPC-information unit and the contextual RPC-information unit thereof.

12. The apparatus according to claim 11, wherein the training module updating the feature vector of the specified RPC-information unit according to the similarity between the specified RPC-information unit and the contextual RPC-information unit thereof comprises:
the training module selecting one or a plurality of RPC-information units from the RPC-information sequence as negative-sample RPC-information units of the specified RPC-information unit;
determines a similarity between the specified RPC-information unit and the negative-sample RPC information units thereof;
determines a loss-representative value corresponding to the specified RPC-information unit according to a specified loss function, the similarity between the specified RPC-information unit and the contextual RPC-information unit thereof, and the similarity between the specified RPC-information unit and the negative sample RPC-information unit thereof; and
updating the feature vector of the specified RPC-information unit according to the loss-representative value.

13. The apparatus according to claim 12, wherein the training module selecting one or a plurality of RPC-information units from the RPC-information sequence as negative-sample RPC-information units of the specified RPC-information unit comprises:
the training module randomly selects one or a plurality of RPC-information units from the RPC-information sequence as the negative-sample RPC-information units of the specified RPC-information unit.

14. The apparatus according to claim 9, wherein the training module training the feature vectors according to the RPC-information sequence and the feature vectors comprises:
the training module traversing the RPC-information sequence, and respectively performing, on traversed RPC-information units, following:
determining one or a plurality of contextual RPC-information units of the RPC-information unit in the RPC-information sequence;
respectively performing, on the contextual RPC-information units, following:
determining a similarity between the RPC-information unit and the contextual RPC-information unit according to a feature vector of the RPC-information unit and a feature vector of the contextual RPC-information unit; and
updating the feature vector of the RPC-information unit and the feature vector of the contextual RPC-information unit according to the similarity between the RPC-information unit and the contextual RPC information unit.

15. The apparatus according to claim 9, wherein the training module training the feature vectors according to the RPC-information sequence and the feature vectors comprises:
the training module traversing the RPC-information sequence, and respectively performing, on RPC-information units in the RPC information-sequence, following:
determining one or a plurality of contextual RPC-information units of the RPC-information unit in the RPC information sequence;
determining a contextual vector according to respective feature vectors of the one or plurality of contextual RPC information units by calculating an average value or maximum and minimum values;
determining a similarity between the RPC-information unit and the contextual RPC-information unit thereof according to a feature vector of the RPC-information unit and the contextual vector; and
updating the feature vectors of the RPC-information unit and the context RPC-information unit thereof according to the similarity between the RPC-information unit and the contextual RPC-information unit thereof.

16. The apparatus according to claim 9, wherein the training module determines one or a plurality of contextual RPC-information units of a particular RPC-information unit in the RPC-information sequence, and wherein determining one or a plurality of contextual RPC-information units of the particular RPC-information unit in the RPC-information sequence comprises:
the training module establishing a window by using the particular RPC information unit as a center and sliding to left and/or right side a distance of a predetermined number of RPC-information units in the RPC-information sequence; and
determining one or a plurality of RPC-information units in the window to serve as the contextual RPC information units.

17. (canceled)

18. A vector-processing device for remote procedure call (RPC) information, comprising:
at least one processor; and
a memory in communication with the at least one processor,
wherein the memory stores instructions executable by the at least one processor, and the instructions are executed by the at least one processor to enable the at least one processor to:
acquire an RPC-information sequence consisting of a plurality of RPC-information units of a user;
establish and initialize feature vectors of the RPC-information units; and
train the feature vectors according to the RPC-information sequence and the feature vectors.

19. The vector-processing device according to claim 18, wherein establishing and initializing feature vectors of the RPC-information units comprises:
determining RPC-information units having an occurrence frequency in the RPC-information sequence no less than a predetermined number; and
establishing and initializing feature vectors of each of the determined RPC-information units, wherein feature vectors for same RPC-information units are also the same.

20. The vector-processing device according to claim 18, wherein training the feature vectors according to the RPC-information sequence and the feature vectors comprises:
determining a specified RPC-information unit in the RPC-information sequence and one or a plurality of contextual RPC-information units of the specified RPC-information unit in the RPC-information sequence;
individually or collectively determining a feature vector for each of the contextual RPC-information units of the specified RPC-information unit as a contextual vector;
determining a similarity between the specified RPC-information unit and the contextual RPC-information unit thereof according to a feature vector of the specified RPC-information unit and the contextual vector; and
updating the feature vector of the specified RPC-information unit according to the similarity between the specified RPC-information unit and the contextual RPC information unit thereof.

21. The vector-processing device according to claim 18, wherein training the feature vectors according to the RPC-information sequence and the feature vectors comprises:
traversing the RPC-information sequence, and respectively performing, on the traversed RPC-information units, following:
determining one or a plurality of contextual RPC-information units of the RPC-information unit in the RPC-information sequence;
respectively performing, on the contextual RPC-information unit, following:
determining a similarity between the RPC-information unit and the contextual RPC-information unit according to a feature vector of the RPC-information unit and a feature vector of the contextual RPC-information unit; and
updating the feature vector of the RPC-information unit and the feature vector of the contextual RPC-information unit according to the similarity between the RPC-information unit and the contextual RPC-information unit.

22. The vector-processing device according to claim 18, wherein training the feature vectors according to the RPC-information sequence and the feature vectors comprises:
traversing the RPC-information sequence, and respectively performing, on RPC information units in the RPC information sequence, following:
determining one or a plurality of contextual RPC-information units of the RPC-information unit in the RPC-information sequence;
determining a contextual vector according to respective feature vectors of the one or plurality of contextual RPC-information units by calculating an average value or maximum and minimum values;
determining a similarity between the RPC information unit and the context RPC information unit thereof according to a feature vector of the RPC information unit and the context vector; and
updating the feature vectors of the RPC-information unit and the contextual RPC-information unit thereof according to the similarity between the RPC-information unit and the contextual RPC-information unit thereof.
